(19) United States
(12) Patent Application Publication
(10) Pub. No.: US 2020/0117559 A1
(43) Pub. Date: Apr. 16, 2020

(54) DATA STORAGE DEVICE AND OPERATING METHOD THEREOF

(71) Applicant: SK hynix Inc., Gyeonggi-do (KR)

(72) Inventor: Jeen PARK, Gyeonggi-do (KR)

(21) Appl. No.: 16/430,000

(22) Filed: Jun. 3, 2019

(30) Foreign Application Priority Data
Oct. 16, 2018 (KR) 10-2018-0123393

(51) Int. Cl. G06F 11/20; G06F 3/06; G06F 12/06

(52) U.S. Cl. CPC G06F 11/2094; G06F 3/0619; G06F 3/064; G06F 2212/1008; G06F 12/0607; G06F 2201/85; G06F 3/0673

(57) ABSTRACT

A data storage device includes a plurality of dies, each of the dies comprising a plurality of planes, and each of the planes comprising a plurality of memory blocks; and a controller controlling an operation of the memory device, wherein the controller generates a super block including memory blocks, among the plurality of memory blocks, determining whether there is a replacement block obtained by way-interleaving, when a bad block is present in the generated super block, and regenerating the super block by replacing the bad block with a replacement block obtained through channel-interleaving, when there is no replacement block being obtained by way-interleaving, wherein the controller assigns the regenerated super block for an operation when data being obtained by channel-interleaving is received, and controlling the memory device to store the data in the regenerated super block.

### CROSS-REFERENCE TO RELATED APPLICATION

The present application claims priority under 35 U.S.C. § 119(a) to Korean application number 10-2018-0123393, filed on Oct. 16, 2018, which is incorporated herein by reference in its entirety.

### BACKGROUND

### 1. Technical Field

Various embodiments of the present invention generally relate to an electronic device. Particularly, the embodiments relate to an electronic device including a controller and a non-transitory machine-readable storage medium.

### 2. Related Art

A memory system may be configured to store data provided from an external device, in response to a write request from the external device. Also, the memory system may be configured to provide stored data to the external device, in response to a read request from the external device. The external device, as an electronic device capable of processing data, may include a computer, a digital camera or a mobile phone. The memory system may be disposed in the external device, or may be a separate component coupled to the external device.

Since there is no mechanical driving part, a memory system using a memory device provides advantages such as excellent stability and durability, high information access speed, and low power consumption. Memory systems having such advantages include a universal serial bus (USB) memory device, memory cards having various interfaces, a universal flash storage (UFS) device, and a solid state drive (SSD).

### SUMMARY

Various embodiments are directed to a data storage device capable of reducing performance degradation even when way interleaving is impossible due to a bad block, and an operating method thereof.

In an embodiment, a data storage device may include: a plurality of dies, each of the dies comprising a plurality of planes, and each of the planes comprising a plurality of memory blocks; and a controller configured to control an operation of the memory device, wherein the controller generates a super block including memory blocks, among the plurality of memory blocks, determines whether there is a replacement block obtained by way-interleaving, when a bad block is present in the generated super block, and regenerates the super block by replacing the bad block with a replacement block obtained through channel-interleaving, when there is no replacement block being obtained by way-interleaving, wherein the controller assigns the regenerated super block for an operation when data being obtained by channel-interleaving is received, and controls the memory device to store the data in the regenerated super block.

In an embodiment, there is an operating method of a data storage device which includes a memory device including a plurality of memory blocks and a controller for controlling an operation of the memory device. The operating method may include the steps of: generating, by the controller, a super block including two or more blocks which can be interleaved, among the plurality of memory blocks; checking, by the controller, whether a bad block occurs in the generated super block; checking, by the controller, whether there is a replacement block which can be way-interleaved, when the bad block occurs; regenerating, by the controller, the super block by replacing the bad block with a replacement block which can be channel-interleaved, when there is no replacement block which can be way-interleaved; assigning, by the controller, the regenerated super block when data which can be channel-interleaved are stored; and controlling, by the controller, the memory device to store the data in the regenerated super block.

In an embodiment, a data storage device includes a memory device including a plurality of dies coupled to each other through a channel, each of the plurality of dies including a plurality of planes, of which planes in the same die are coupled to each other through a common way, and each of the plurality of planes including a plurality of memory blocks; and a controller suitable for: generating a super block including memory blocks, among the plurality of memory blocks; when it is determined that a bad memory block is present in the super block, determining whether there is a first replacement memory block in a plane, among the plurality of planes, coupled to the plane in which the bad memory block is present through a common way; when it is determined that there is no first replacement memory block, regenerating the super block by replacing the bad memory block with a second replacement memory block in a die different from, but coupled to, the die in which the bad memory block is present, through the channel; and storing data in the regenerated super block.

### BRIEF DESCRIPTION OF THE DRAWINGS

FIG. 1 is a block diagram illustrating a data storage device in accordance with an embodiment.

FIG. 2 is a diagram illustrating a memory, such as that of FIG. 1.

FIG. 3 is a diagram illustrating a data storage region included in a nonvolatile memory device in accordance with an embodiment.

FIG. 4 is a block diagram illustrating a flash translation layer (FTL) in accordance with an embodiment.

FIG. 5 is a flowchart illustrating an operating method of a data storage device in accordance with an embodiment.

FIG. 6 is a flowchart illustrating a specific example of the method illustrated in FIG. 5.

FIG. 7 is a diagram illustrating data which can be channel-interleaved in accordance with an embodiment.

FIG. 8 is a block diagram illustrating a data processing system including a solid state drive (SSD) in accordance with an embodiment.

FIG. 9 is a block diagram illustrating a controller of FIG. 8.

FIG. 10 is a diagram illustrating a data processing system including a data storage device in accordance with an embodiment.

FIG. 11 is a diagram illustrating a data processing system including a data storage device in accordance with an embodiment.

FIG. 12 is a diagram illustrating a network system including a data storage device in accordance with an embodiment.

FIG. 13 is a block diagram illustrating a nonvolatile memory device included in a data storage device in accordance with an embodiment.

### DETAILED DESCRIPTION

A data storage device and an operating method thereof are described below with reference to the accompanying drawings through various embodiments. Throughout the specification, reference to “an embodiment,” “another embodiment” or the like is not necessarily to only one embodiment, and different references to any such phrase are not necessarily to the same embodiment(s).

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present. Communication between two elements, whether directly or indirectly connected/coupled, may be wired or wireless, unless stated or the context indicates otherwise.

As used herein, singular forms may include the plural forms as well and vice versa, unless the context clearly indicates otherwise. The articles ‘a’ and ‘an’ as used in this application and the appended claims should generally be construed to mean ‘one or more’ unless specified otherwise or clear from context to be directed to a singular form.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

FIG. 1 illustrates a configuration of a data storage device 10 in accordance with an embodiment.

Referring to FIG. 1, the data storage device 10 may store data which may be accessed by a host device 20 such as a mobile phone, MP3 player, laptop computer, desktop computer, game machine, TV or in-vehicle infotainment system. The data storage device 10 may be referred to as a memory system.

The data storage device 10 may be configured as any of various types of storage devices, according to an interface protocol coupled to the host device 20. For example, the data storage device 10 may be configured as any of a solid state drive (SSD), a multimedia card (MMC) such as an eMMC, RS-MMC or micro-MMC, a secure digital (SD) card such as a mini-SD or micro-SD, a universal serial bus (USB) storage device, a universal flash storage (UFS) device, a personal computer memory card international association (PCMCIA) card-type storage device, a peripheral component interconnection (PCI) card-type storage device, a PCI express (PCI-E) card-type storage device, a compact flash (CF) card, a smart media card and a memory stick.

The data storage device 10 may be fabricated as any one of various types of packages, such as a package-on-package (POP), a system-in-package (SIP), a system-on-chip (SOC), a multi-chip package (MCP), a chip-on-board (COB) package, a wafer-level fabricated package (WFP) and a wafer-level stack package (WSP).

The data storage device 10 may include a nonvolatile memory device 100 and a controller 200.

The nonvolatile memory device 100 may operate as a storage medium of the data storage device 10. The nonvolatile memory device 100 may be configured as any of various types of nonvolatile memory devices including a NAND flash memory device, a NOR flash memory device, a ferroelectric random access memory (FRAM) using a ferroelectric capacitor, a magnetic RAM (MRAM) using a tunneling magneto-resistive (TMR) film, a phase change RAM (PRAM) using chalcogenide alloys, and a resistive RAM (ReRAM) using transition metal oxide, depending on memory cells.

FIG. 1 illustrates that the data storage device 10 includes one nonvolatile memory device 100. However, this is only an example; the data storage device 10 may include a plurality of nonvolatile memory devices. The present disclosure may be applied in the same manner to a data storage device 10 including a plurality of nonvolatile memory devices.

The nonvolatile memory device 100 may include a memory cell array (not illustrated) having a plurality of memory cells arranged at the respective intersections between a plurality of bit lines (not illustrated) and a plurality of word lines (not illustrated). The memory cell array may include a plurality of memory blocks, and each of the memory blocks may include a plurality of pages.

For example, each of the memory cells of the memory cell array may be a single level cell (SLC) capable of storing 1-bit data or a multi-level cell (MLC) capable of storing 2 or more-bit data. The MLC may store 2-bit data, 3-bit data, 4-bit data or the like. In general, a memory cell for storing 2-bit data may be referred to as an MLC, a memory cell for storing 3-bit data may be referred to as a triple level cell (TLC), and a memory cell for storing 4-bit data may be referred to as a quadruple level cell (QLC). Here, however, the memory cells for storing 2-bit, 3-bit and 4-bit data may be collectively referred to as MLCs for convenience of description.

The memory cell array 110 may include one or more of the SLCs and the MLCs. Furthermore, the memory cell array 110 may include memory cells with a two-dimensional horizontal structure or memory cells with a three-dimensional vertical structure.

The controller 200 may control overall operations of the data storage device 10 by driving firmware or software loaded to a memory 230. The controller 200 may decode and drive a code-based instruction or algorithm such as firmware or software. The controller 200 may be implemented in hardware or a combination of hardware and software.

The controller 200 may include a host interface 210, a processor 220, the memory 230 and a memory interface 240. Although not illustrated in FIG. 1, the controller 200 may further include an error correction code (ECC) engine which generates parity data by performing ECC encoding on write data provided from a host device, and performs ECC decoding on read data read from the nonvolatile memory device 100 using parity data.

The host interface 210 may interface the host device 20 and the data storage device 10 in response to a protocol of the host device 20. For example, the host interface 210 may communicate with the host device 20 through any of the following protocols: USB (universal serial bus), UFS (universal flash storage), MMC (multimedia card), PATA (parallel advanced technology attachment), SATA (serial advanced technology attachment), SCSI (small computer system interface), SAS (serial attached SCSI), PCI (peripheral component interconnection) and PCI-E (PCI express).

The processor 220 may include a micro control unit (MCU) and/or a central processing unit (CPU). The processor 220 may process a request transferred from the host device 20. In order to process the request transferred from the host device 20, the processor 220 may drive a code-based instruction or algorithm, i.e. firmware, which is loaded to the memory 230, and control the nonvolatile memory device 100 and internal function blocks such as the host interface 210, the memory 230 and the memory interface 240.

The processor 220 may generate control signals for controlling an operation of the nonvolatile memory device 100, based on requests transferred from the host device 20, and provide the generated control signals to the nonvolatile memory device 100 through the memory interface 240.

The memory 230 may be configured as a random access memory such as a dynamic RAM (DRAM) or static RAM (SRAM). The memory 230 may store the firmware driven by the processor 220. Furthermore, the memory 230 may store data required for driving the firmware, for example, meta data. That is, the memory 230 may operate as a working memory of the processor 220.

The memory 230 may include a data buffer for temporarily storing write data to be transferred to the nonvolatile memory device 100 from the host device 20 or read data to be transferred to the host device 20 from the nonvolatile memory device 100. That is, the memory 230 may operate as a buffer memory.

The memory interface 240 may control the nonvolatile memory device 100 under control of the processor 220. The memory interface 240 may be referred to as a memory controller. The memory interface 240 may provide control signals to the nonvolatile memory device 100. The control signals may include a command, address and operation control signal for controlling the nonvolatile memory device 100. The memory interface 240 may provide data stored in the data buffer to the nonvolatile memory device 100 or store data transferred from the nonvolatile memory device 100 in the data buffer.

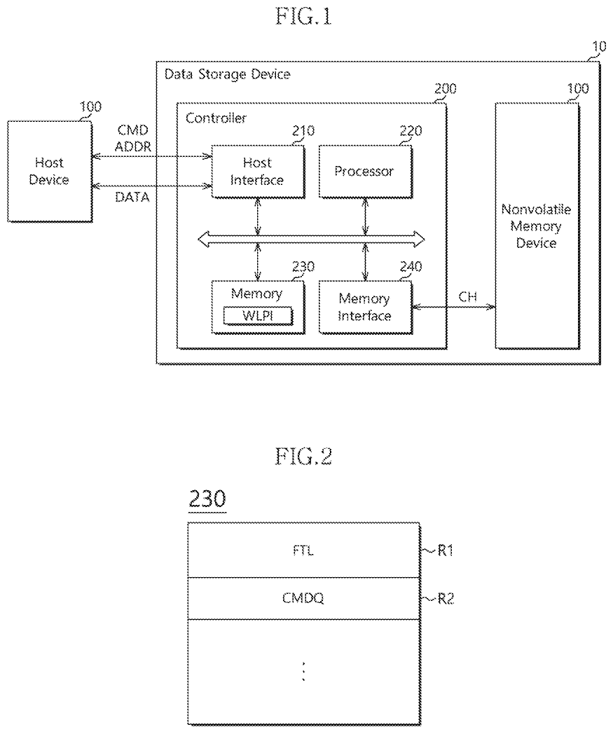

FIG. 2 illustrates the memory of FIG. 1.

Referring to FIG. 2, the memory 230 in accordance with an embodiment may include a first region R1 in which a flash translation layer (FTL) is stored and a second region R2 which is used as a command queue CMDQ for queuing a command corresponding to a request provided from the host device 20. Although not shown, the memory 230 may further include regions for various other uses, such as a region used as a write data buffer for temporarily storing write data, a region used as a read data buffer for temporarily storing read data, and a region used as a map cache buffer for caching map data, as is known in the art.

The memory 230 may include a region for storing system data or meta data, which is not illustrated. Workload pattern information (WLPI) of FIG. 1 may be stored in the region for storing system data or meta data in the memory 230.

When the nonvolatile memory device 100 is configured as a flash memory device, the processor 220 may control operation of the nonvolatile memory device 100, and drive the FTL, which may be software, in order to provide device compatibility to the host device 20. As the FTL is driven, the data storage device 10 may be recognized and used as a general data storage device such as a hard disk by the host device 20.

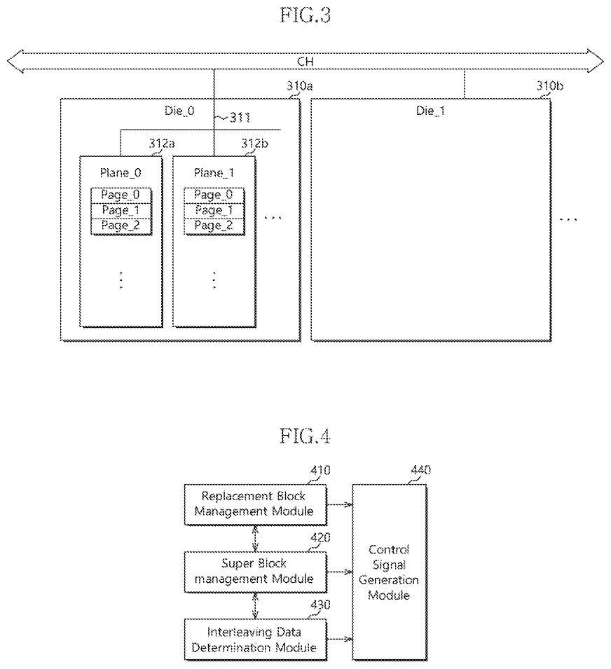

The FTL stored in the first region R1 of the memory 230 may include modules for performing various functions and meta data required for driving the respective modules. The FTL may be stored in a system region (not illustrated) of the nonvolatile memory device 100. When the data storage device 10 is powered on, the FTL may be read from the system region of the nonvolatile memory device 100 and loaded to the first region R1 of the memory 230. FIG. 3 is a diagram illustrating a data storage region included in a nonvolatile memory device 100 in accordance with an embodiment.

Referring to FIG. 3, the nonvolatile memory device 100 may include a plurality of dies 310a and 310b which share a channel CH coupled to a controller 200. Each of the dies 310a and 310b may include a plurality of planes 312a and 312b which share a way 311 coupled to the channel. Each of the planes 312a and 312b may include a plurality of pages. Each of the pages may define a minimum unit of storage used for reading or writing data. Furthermore, a plurality of pages which are collectively erased may be referred to as a block, and a plurality of blocks which are managed as one block may be referred to as a super block. Therefore, a data storage region in the nonvolatile memory device 100 may include a die, plane, super block, block, or page. However, in the following description, the data storage region may indicate a page unless specifically noted otherwise.

FIG. 4 is a block diagram illustrating a flash translation layer (FTL) in accordance with an embodiment.

Referring to FIG. 4, the FTL may include a replacement block management module 410, a super block management module 420, an interleaving data determination module 430 and a control signal generation module 440.

The replacement block management module 410 may manage a replacement block. Specifically, the replacement block management module 410 may manage a replacement block which is a memory block for replacing a memory block determined as a bad block. The replacement block may be present in each of the planes, and a user's access to the replacement block may be limited.

In an embodiment, the replacement block management module 410 may store an address list of replacement blocks.

The super block management module 420 may manage a super block including a plurality of memory blocks. Specifically, the super block management module 420 may generate a super block for managing two or more memory blocks among the plurality of memory blocks included in the memory device 100 as a group. The super block may indicate the unit of a read operation which is performed in the memory device 100.

In an embodiment, the super block management module 420 may generate a super block by mapping addresses of two or more memory blocks.

The super block management module 420 may regenerate a super block. Specifically, the super block management module 420 may determine whether any memory block in a super block is a bad block. When a bad block is determined to exist in the super block, the super block management module 420 may request a replacement block for the bad block from the replacement block management module 410. When an available replacement block is present in a plane in which the memory block identified as the bad block is also present, the super block management module 420 may regenerate a super block by replacing the bad memory block with the replacement block from the same plane. On the other hand, when no replacement block is present in the same plane, the super block management module 420 may regenerate a super block by replacing the bad memory block with a replacement block in another plane.

In an embodiment, it determined whether there is a replacement block that can be obtained by way-interleaving, that is a replacement block is present in a plane of the same die in which the bad block resides, which planes are coupled by a common way. If so, the bad block is replaced by such replacement block in a different plane than that of the bad block but in the same die. Only when there is no replacement block present a different plane of the same die, which can be obtained through way-interleaving, the super block management module 420 may regenerate a super block by replacing the memory block identified as the bad block with a replacement block from a different plane in a different die, which can be obtained through channel-interleaving.

In an embodiment, the super block management module 420 may regenerate a super block by replacing the address of the memory block identified as the bad block with the address of a replacement block.

In an embodiment, when the bad memory block is replaced with a replacement block which can be obtained through channel-interleaving, the super block management module 420 may regenerate a super block by applying a replacement block present in a die different from the die in which the bad memory block is present.

The interleaving data determination module 430 may determine whether to assign the regenerated super block for an operation. Specifically, if a super block is regenerated with a replacement block which is obtained through channel-interleaving, because there is no replacement block which can be obtained through way-interleaving, the interleaving data determination module 430 may assign the regenerated super block when data are stored in the regenerated super block.

In an embodiment, when the regenerated super block includes N memory blocks and M memory blocks of the N memory blocks are obtainable only by channel-interleaving, in that case the interleaving data determination module 430 may assign the regenerated super block such that received data having a size that can be stored in (N-M) memory blocks are to be stored in such memory blocks in the memory device 100.

The control signal generation module 440 may generate a control signal for controlling the data storage device 10 to store data in the assigned regenerated super block. The controller and the memory device 100 may perform an operation of storing data in the assigned regenerated super block according to the generated control signal.

The block diagram of the FTL in FIG. 4 illustrates firmware in terms of functions, but the FTL may be configured in hardware. For example, the FTL may be configured as a separate circuit or the like.

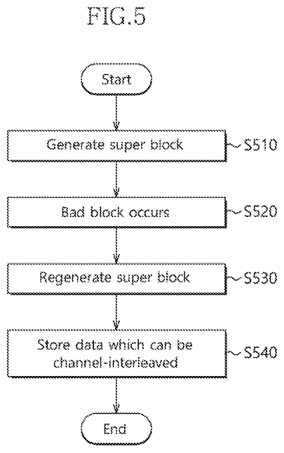

FIG. 5 is a flowchart illustrating an operating method of a data storage device (e.g., the data storage device 10 of FIG. 1) in accordance with an embodiment. Hence, at least some of the functionality of the data storage device 10, as previously described, is applicable to the method.

Referring to FIG. 5, a super block may be generated at step S510. Specifically, the data storage device 10 may generate a super block including two or more blocks of the plurality of memory blocks included in the memory device 100.

In an embodiment, the data storage device 10 may generate a super block such that way interleaving is possible. For example, the data storage device 10 may generate a super block including two or more memory blocks which are in different planes, respectively.

At step S520, it is determined that a bad block occurs, i.e., is present in the super block. Specifically, the data storage device 10 may monitor write operations for the memory blocks included in the super block, and determine that a memory block in which a write fail occurs is a bad block.

At step S530, a super block may be regenerated. Specifically, the data storage device 10 may regenerate a super block by replacing the memory block determined as a bad block with a replacement block, among available replacement blocks.

In an embodiment, when the replacement blocks include a memory block which can be obtained by way-interleaving, the data storage device 10 may regenerate a super block by preferentially applying the memory block which can be way-interleaved. For example, when a replacement block is present in a plane in which the memory block determined as the bad block is also present, the data storage device 10 may regenerate a super block by replacing the bad memory block determined with such replacement block in the same plane. This is done by way-interleaving because the plane in which the bad block resides and the plane in which the replacement block resides, although different, are in the same die, and hence coupled by a common way.

In an embodiment, when there is no replacement block which can be obtained by way-interleaving, the data storage device 10 may regenerate a super block by replacing the bad memory block with a replacement block which can be obtained by channel-interleaved. For example, when a replacement block is not present in the plane in which the memory block determined as the bad block is also present but such replacement block is present in another plane, the data storage device 10 may regenerate a super block by replacing the bad memory block with the corresponding replacement block in the other plane.

In an embodiment, when there are replacement blocks which can be obtained only by channel-interleaving, the data storage device 10 may regenerate a super block by applying a replacement block present in a die different from the die including the memory block determined as the bad block. This is done by channel-interleaving because the die in which the bad block resides and the die in which the replacement block resides, although different, are coupled by the channel.

At step S540, data may be stored in the regenerated super block. Specifically, when the regenerated super block includes N memory blocks and M memory blocks of the N memory blocks cannot be way-interleaved, the data storage device 10 may store data in the regenerated super block, the data having a size that can be stored in (N-M) memory blocks.

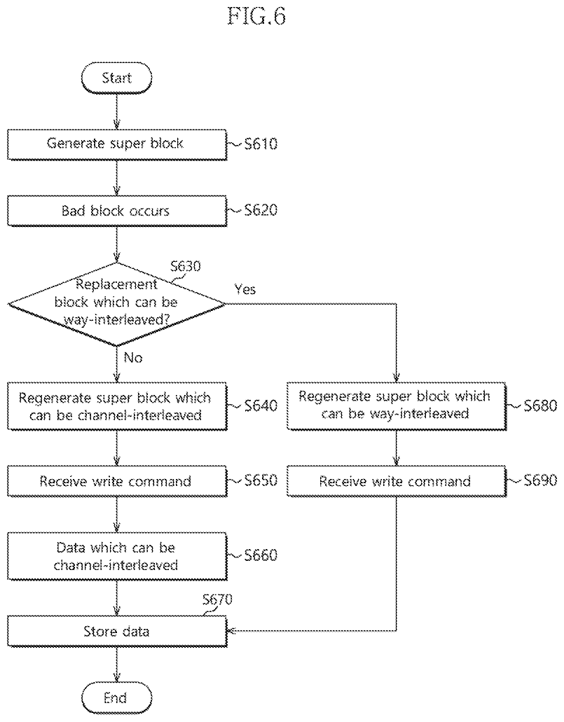

FIG. 6 illustrates a specific example of the operating method of the data storage device 10 illustrated in FIG. 5.

Referring to FIG. 6, a super block may be generated at step S610. Specifically, the data storage device 10 may generate a super block including two or more memory blocks of the plurality of memory blocks included in the memory device 100, such that memory blocks therein may be processed by way interleaving.

At step S620, it is determined that a bad block occurs, i.e., is present in the generated super block. Specifically, the data storage device 10 may monitor write operations for the memory blocks included in the generated super block, and determine that a memory block in which a write fail occurs is a bad block.

At step S630, the data storage device 10 may check whether there is a replacement block which can be way-interleaved into the super block. Specifically, the data storage device 10 may check whether there is, among available replacement blocks for the bad block, a replacement block which can be way-interleaved and/or a replacement block which can be channel-interleaved into the super block. When it is determined that there is a replacement block that can be obtained by way-interleaving (S630, YES), step S680 may be performed. When it is determined that there is no replacement block that can be obtained by way-interleaving (S630, NO), step S640 may be performed.

At step S640, a super block which can be channel-interleaved may be regenerated. Specifically, the data storage device 10 may regenerate a super block by replacing the memory block determined as the bad block with a replacement block which can be channel-interleaved. That is, a replacement block is obtained from a different die than the die containing the bad block.

At step S650, a write command may be received. Specifically, the data storage device 10 may receive the write command and data from the host.

At step S660, the data storage device 10 may check whether data can be channel-interleaved. Specifically, the data storage device 10 may check whether the data received from the host can be stored in the regenerated super block by channel-interleaving. If the data cannot be channel-interleaved, the data storage device 10 allocates other superblock and stores the data in the allocated superblock.

At step S670, the data may be stored. Specifically, the data storage device 10 may store the data received from the host in the regenerated super block.

At step S680, a super block which can be way-interleaved may be regenerated. Specifically, when there is a replacement block which can be obtained by way-interleaving, the data storage device 10 may regenerate a super block by replacing the bad memory block determined with a replacement block from the same plane, i.e., a memory block which can be way-interleaved.

At step S690, write data may be received. Specifically, the data storage device 10 may receive a write command and data from the host. Then, the data storage device 10 may store the received data in the regenerated super block at step S670.

FIG. 7 is a diagram illustrating data which can be channel-interleaved in accordance with an embodiment.

Referring to FIG. 7, two dies Die_0 and Die_1 which can be channel-interleaved are illustrated. Each of the dies (Die_0 and Die_1) may include two planes (Plane_0 and Plane_1) each including four blocks (BLK_0 to BLK_3). Blocks and data in planes of the same die can be way-interleaved. Furthermore, FIG. 7 illustrates three super blocks (Super BLK_0 to Super BLK_2) and four replacement blocks. Super BLK_0 includes four blocks: BLK0 in all four planes. Super BLK_1 includes four blocks BLK1: BLK1 in all four planes. Super BLK_2 includes four blocks: BLK2 in all four planes. Each of the three super blocks Super BLK_0 to Super BLK_2 may have memory blocks which can be way-interleaved. The four replacement blocks are the memory blocks BLK_3 of the respective planes. Furthermore, in FIG. 7, the memory blocks BLK_1 and BLK_3 in the plane Plane_1 of the die Die_0 are determined as bad blocks.

The data storage device 10 may regenerate a super block by replacing the memory block BLK_1, which is in the plane Plane_1 of the die Die_0 and determined as a bad block, with the memory block BLK_3 in the plane Plane_0 of the die Die_1. When data are stored in the super block Super Block_0, the block BLK_1 in the plane Plane_1 of the die Die_0 and the block BLK_3 in the plane Plane_0 of the die Die_1 may not share the same way, but share the same channel. Thus, channel interleaving can be performed. Therefore, when data which can be stored in two blocks are stored in the super block Super Block_1, it is possible to obtain a similar effect to the effect of the way interleaving through the channel interleaving.

In accordance with embodiments, performance degradation of the data storage device may be reduced, even when a replacement for a bad block is not obtainable through way interleaving.

While various embodiments have been illustrated and described, it will be understood by those skilled in the art that the embodiments described are examples only. Accordingly, the operating method of the data storage device described herein should not be limited based on the described embodiments.

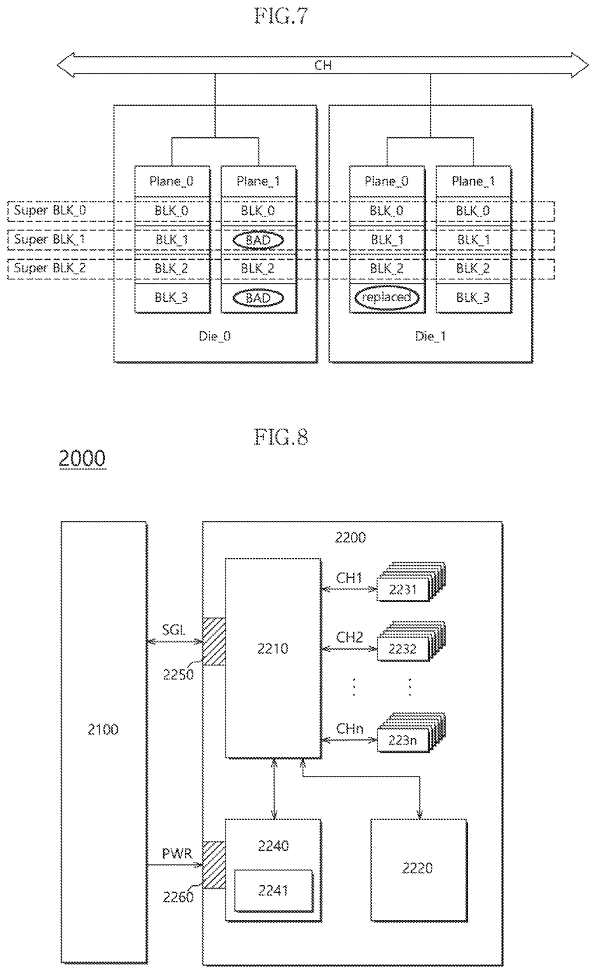

FIG. 8 illustrates a data processing system 2000 including a solid state drive (SSD) in accordance with an embodiment. Referring to FIG. 8, the data processing system 2000 may include a host device 2100 and an SSD 2200.

The SSD 2200 may include a controller 2210, a buffer memory device 2220, nonvolatile memory devices 2231 to 223n, a power supply 2240, a signal connector 2250 and a power connector 2260.

The controller 2210 may control overall operations of the SSD 2200.

The buffer memory device 2220 may temporarily store data which are to be stored in the nonvolatile memory devices 2231 to 223n. Furthermore, the buffer memory device 2220 may temporarily store data read from the nonvolatile memory devices 2231 to 223n. The data which are temporarily stored in the buffer memory device 2220 may be transferred to the host device 2100 or the nonvolatile memory devices 2231 to 223n under control of the controller 2210.

The nonvolatile memory devices 2231 to 223n may be used as storage media of the SSD 2200. The nonvolatile memory devices 2231 to 223n may be coupled to the controller 2210 through a plurality of channels CH1 to CHn. One or more nonvolatile memory devices may be coupled to one channel. The nonvolatile memory devices coupled to one channel may be coupled to the same signal bus and data bus.

The power supply 2240 may provide power PWR inputted through the power connector 2260 into the SSD 2200. The power supply 2240 may include an auxiliary power supply 2241. The auxiliary power supply 2241 may supply power to properly turn off the SSD 2200, when a sudden power off occurs. The auxiliary power supply 2241 may include large capacitors capable of storing power PWR.

The controller 2210 may exchange signals SGL with the host device 2100 through the signal connector 2250. The signal SGL may include a command, address, and data. The signal connector 2250 may be configured as any of various types of connectors depending on an interface method between the host device 2100 and the SSD 2200.

FIG. 9 illustrates a configuration of the controller 2210 of FIG. 8. Referring to FIG. 9, the controller 2210 may include a host interface 2211, a control component 2212, a random access memory (RAM) 2213, an error correction code (ECC) component 2214 and a memory interface 2215.

The host interface 2211 may interface the host device 2100 and the SSD 2200 according to a protocol of the host device 2100. For example, the host interface 2211 may communicate with the host device 2100 through any of the following protocols: secure digital, Universal Serial Bus (USB), Multi-Media Card (MMC), Embedded MMC (eMMC), Personal Computer Memory Card International Association (PCMCIA), Parallel Advanced Technology Attachment (PATA), Serial Advanced Technology Attachment (SATA), Small Computer System Interface (SCSI), Serial Attached SCSI (SAS), Peripheral Component Interconnection (PCI), PCI Express (PCI-e or PCIe) and Universal Flash Storage (UFS). The host interface 2211 may perform a disk emulation function which supports the host device 2100 to recognize the SSD 2200 as a universal data storage device, for example, a hard disk drive (HDD).

The control component 2212 may analyze and process the signal SGL inputted from the host device 2100. The control component 2212 may control operations of internal function blocks according to firmware or software for driving the SSD 2200. The RAM 2213 may be used as a working memory for driving such firmware or software.

The ECC component 2214 may generate parity data of the data which are to be transferred to the nonvolatile memory devices 2231 to 223n of FIG. 8. The generated parity data and the data may be stored in the nonvolatile memory devices 2231 to 223n. The ECC component 2214 may detect an error of data read from the nonvolatile memory devices 2231 to 223n based on the parity data. When the detected error falls within a correctable range, the ECC component 2214 may correct the detected error.

The memory interface 2215 may provide a control signal such as a command and address to the nonvolatile memory devices 2231 to 223n, under control of the control component 2212. The memory interface 2215 may exchange data with the nonvolatile memory devices 2231 to 223n, under control of the control component 2212. For example, the memory interface 2215 may provide data stored in the buffer memory device 2220 to the nonvolatile memory devices 2231 to 223n, or provide data read from the nonvolatile memory devices 2231 to 223n to the buffer memory device 2220.

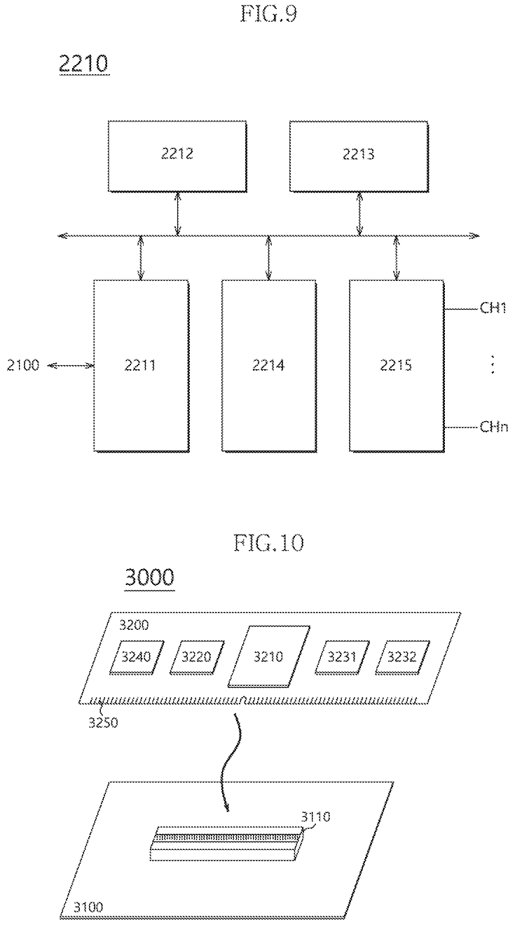

FIG. 10 illustrates a data processing system 3000 including a data storage device in accordance with an embodiment. Referring to FIG. 10, the data processing system 3000 may include a host device 3100 and a data storage device 3200.

The host device 3100 may be configured as a board such as a printed circuit board (PCB). Although not illustrated, the host device 3100 may include internal function blocks for performing a function of the host device 3100.

The host device 3100 may include a connection terminal 3110 such as a socket, slot or connector. The data storage device 3200 may be mounted on the connection terminal 3110.

The data storage device 3200 may be configured as a board such as a PCB. The data storage device 3200 may be referred to as a memory module or memory card. The data storage device 3200 may include a controller 3210, a buffer memory device 3220, nonvolatile memory devices 3231 and 3232, a power management integrated circuit (PMIC) 3240 and a connection terminal 3250.

The controller 3210 may control overall operations of the data storage device 3200. The controller 3210 may be configured in the same manner as the controller 2210 illustrated in FIG. 9.

The buffer memory device 3220 may temporarily store data which are to be stored in the nonvolatile memory devices 3231 and 3232. Furthermore, the buffer memory device 3220 may temporarily store data read from the nonvolatile memory devices 3231 and 3232. The data which are temporarily stored in the buffer memory device 3220 may be transferred to the host device 3100 or the nonvolatile memory devices 3231 and 3232 under control of the controller 3210.

The nonvolatile memory devices 3231 to 3232 may be used as storage media of the data storage device 3200.

The PMIC 3240 may provide power inputted through the connection terminal 3250 into the data storage device 3200. The PMIC 3240 may manage the power of the data storage device 3200 under control of the controller 3210.

The connection terminal 3250 may be coupled to the connection terminal 3110 of the host device 3100. Through the connection terminal 3250, signals and power may be transferred between the host device 3100 and the data storage device 3200, the signals including a command, address, and data. The connection terminal 3250 may be configured in various manners depending on an interface method between the host device 3100 and the data storage device 3200. The connection terminal 3250 may be disposed at any one side of the data storage device 3200.

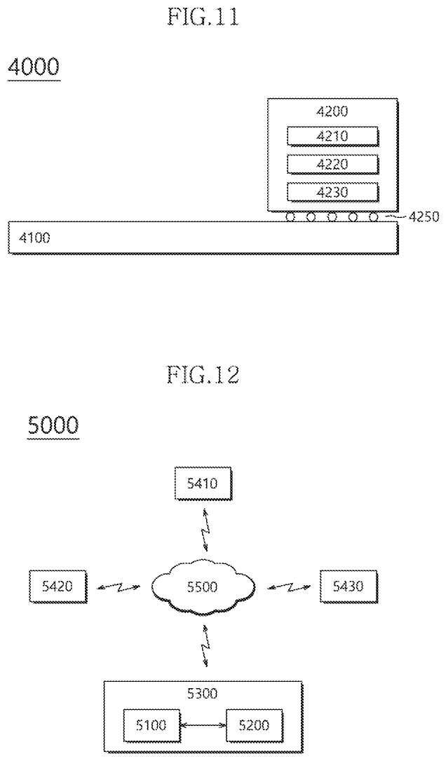

FIG. 11 illustrates a data processing system 4000 including a data storage device in accordance with an embodiment. Referring to FIG. 11, the data processing system 4000 may include a host device 4100 and a data storage device 4200.

The host device 4100 may be configured as a board such as a PCB. Although not illustrated, the host device 4100 may include internal function blocks for performing a function of the host device.

The data storage device 4200 may be configured as a surface mount package. The data storage device 4200 may be mounted on the host device 4100 through solder balls 4250. The data storage device 4200 may include a controller 4210, a buffer memory device 4220 and a nonvolatile memory device 4230.

The controller 4210 may control overall operations of the data storage device 4200. The controller 4210 may be configured in the same manner as the controller 2210 illustrated in FIG. 9.

The buffer memory device 4220 may temporarily store data which are to be stored in the nonvolatile memory device 4230. Furthermore, the buffer memory device 4220 may temporarily store data read from the nonvolatile memory device 4230. The data which are temporarily stored in the buffer memory device 4220 may be transferred to the host device 4100 or the nonvolatile memory device 4230 under control of the controller 4210.

The nonvolatile memory device 4230 may be used as a storage medium of the data storage device 4200.

FIG. 12 illustrates a network system 5000 including a data storage device in accordance with an embodiment of the present invention. Referring to FIG. 12, the network system 5000 may include a server system 5300 and a plurality of client systems 5410 to 5430 which are connected through a network 5500.

The server system 5300 may provide data in response to requests of the plurality of client systems 5410 to 5430. For example, the server system 5300 may store data provided from the plurality of client systems 5410 to 5430. For another example, the server system 5300 may provide data to the plurality of client systems 5410 to 5430.

The server system 5300 may include a host device 5100 and a data storage device 5200. The data storage device 5200 may be configured as the data storage device 10 of FIG. 1, the data storage device 2200 of FIG. 8, the data storage device 3200 of FIG. 10 or the data storage device 4200 of FIG. 11.

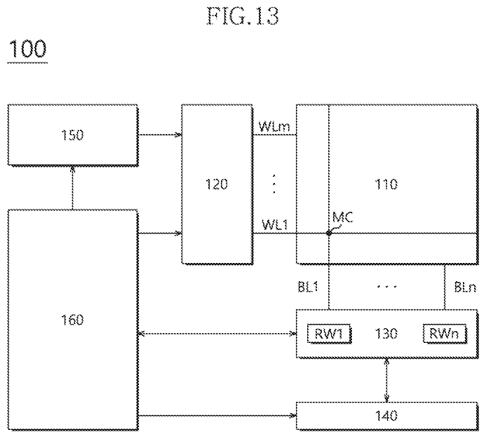

FIG. 13 is a block diagram illustrating a nonvolatile memory device 100 included in a data storage device in accordance with an embodiment. Referring to FIG. 13, the nonvolatile memory device 100 may include a memory cell array 110, a row decoder 120, a column decoder 130, a data read and write (read/write) block 140, a voltage generator 150 and control logic 160.

The memory cell array 110 may include memory cells MC arranged at the respective intersections between word lines WL1 to WLm and bit lines BL1 to BLn.

The row decoder 120 may be coupled to the memory cell array 110 through the word lines WL1 to WLm. The row decoder 120 may operate under control of the control logic 160. The row decoder 120 may decode an address provided from an external device (not illustrated). The row decoder 120 may select and drive the word lines WL1 to WLm based on the decoding result. For example, the row decoder 120 may provide word line voltages received from the voltage generator 150 to the word lines WL1 to WLm.

The data read/write block 140 may be coupled to the memory cell array 110 through the bit lines BL1 to BLn. The data read/write block 140 may include read/write circuits RW1 to RWn corresponding to the respective bit lines BL1 to BLn. The data read/write block 140 may operate under control of the control logic 160. The data read/write block 140 may operate as a write driver or sense amplifier depending on operation modes. For example, the data read/write block 140 may operate as a write driver which stores data provided from the external device in the memory cell array 110, during a write operation. For another example, the data read/write block 140 may operate as a sense amplifier which reads data from the memory cell array 110, during a read operation.

The column decoder 130 may operate under control of the control logic 160. The column decoder 130 may decode an address provided from the external device. The column decoder 130 may couple the read/write circuits RW1 to RWn of the data read/write block 140, corresponding to the respective bit lines BL1 to BLn, to a data input/output line (or data input/output buffer) according to the decoding result.

The voltage generator 150 may generate a voltage which is used for an internal operation of the nonvolatile memory device 100. The voltages generated by the voltage generator 150 may be applied to the memory cells of the memory cell array 110. For example, a program voltage generated during a program operation may be applied to a word line of memory cells on which the program operation is to be performed. For another example, an erase voltage generated during an erase operation may be applied to well regions of memory cells on which the erase operation is to be performed. For another example, a read voltage generated during a read operation may be applied to a word line of memory cells on which the read operation is to be performed.

The control logic 160 may control overall operations of the nonvolatile memory device 100 based on a control signal provided from the external device. For example, the control logic 160 may control an operation of the nonvolatile memory device 100, such as a read, write or erase operation of the nonvolatile memory device 100.

In accordance with embodiment of the present invention, the lifetime of the memory device may be effectively extended.

While various embodiments have been illustrated and described, it will be understood to those skilled in the art that the embodiments described are examples only. Accordingly, the is not limited based on the described embodiments. Rather, the present invention encompasses all variations and modifications that fall within the scope of the claims.

What is claimed is:

1. A data storage device comprising:
a memory device comprising a plurality of dies, each of the dies comprising a plurality of planes, and each of the planes comprising a plurality of memory blocks; and
a controller configured to control an operation of the memory device,
wherein the controller generates a super block including memory blocks, among the plurality of memory blocks, determines whether there is a replacement block obtained by way-interleaving, when a bad block is present in the generated super block, and regenerates the super block by replacing the bad block with a replacement block obtained through channel-interleaving, when there is no replacement block being obtained by way-interleaving,
wherein the controller assigns the regenerated super block for an operation when data being obtained by channel-interleaving is received, and controls the memory device to store the data in the regenerated super block.

2. The data storage device according to claim 1, wherein the controller generates the super block based on memory blocks included in different planes.

3. The data storage device according to claim 1, wherein, when a write fail occurs in a memory block in the generated super block, the controller determines that the memory block in which the write fail occurs to be the bad block.

4. The data storage device according to claim 1, wherein when it is determined that a replacement block is present in a plane including the bad block, the controller determines that a memory block being obtained by way-interleaving is present.

5. The data storage device according to claim 1, wherein when a replacement block is present in a plane including a memory block which is not determined as a bad block among the memory blocks in the generated super block, the controller determines that a memory block being obtained by channel-interleaving is present.

6. The data storage device according to claim 5, wherein the controller regenerates the super block by applying a replacement block which is present in a die different from a die including a memory block determined as the bad block among blocks being obtained by channel-interleaving.

7. The data storage device according to claim 2, wherein when the regenerated super block includes N memory blocks and M memory blocks of the N memory blocks are memory blocks which can be obtained by channel-interleaving, the controller assigns the regenerated super block such that data having a size being stored in (N-M) memory blocks are stored in the (N-M) memory blocks.

8. An operating method of a data storage device which includes a memory device including a plurality of memory blocks and a controller for controlling the memory device, the operating method comprising:
generating, by the controller, a super block including memory blocks, among the plurality of memory blocks;
determining, by the controller, whether a bad block is present in the generated super block;
checking, by the controller, whether there is a first replacement block being obtained by way-interleaving, when it is determined that the bad block is present;
regenerating, by the controller, the super block by replacing the bad block with a second replacement block obtained by channel-interleaving, when there is no first replacement block obtained by way-interleaving;
assigning, by the controller, the regenerated super block for an operation when data obtained by channel-interleaving is received; and
controlling, by the controller, the memory device to store the data in the regenerated super block.

9. The operating method according to claim 8, wherein the memory device comprises a plurality of dies sharing a channel coupled to the controller,
wherein each of the dies comprises a plurality of planes sharing a way coupled to the channel, and
each of the planes comprises one or more replacement blocks to which a user's access is limited.

10. The operating method according to claim 9, wherein the memory blocks included in the generated super block are positioned in different planes.

11. The operating method according to claim 9, wherein the determining of whether the bad block is present comprises determining that a memory block in which a write fail occurs, among memory blocks, is a bad block.

12. The operating method according to claim 9, wherein the checking of whether there is a first replacement block comprises determining that there is a block being obtained by way-interleaving, when it is determined that a replacement block is present in a plane in which a memory block determined as the bad block is present.

13. The operating method according to claim 9, wherein the checking of whether there is a first replacement block comprises determining that there is a block being obtained by channel-interleaving, when a replacement block is present in a plane in which no memory block is determined as a bad block among the memory blocks included in the generated super block.

14. The operating method according to claim 13, wherein the regenerating of the super block comprises regenerating the super block by applying a replacement block which is present in a die different from a die including a memory block determined as the bad block among blocks which can be obtained by channel-interleaving.

15. The operating method according to claim 9, wherein the assigning the regenerated super block comprises assigning the regenerated super block in the case that data having a size which can be stored in (N-M) memory blocks are stored in the (N-M) memory blocks, when the regenerated super block includes N memory blocks and M memory blocks of the N memory blocks are memory blocks being obtained by channel-interleaving.

16. A data storage device comprising:
a memory device including a plurality of dies coupled to each other through a channel, each of the plurality of dies including a plurality of planes, of which planes in the same die are coupled to each other through a common way, and each of the plurality of planes including a plurality of memory blocks; and
a controller suitable for:
generating a super block including memory blocks, among the plurality of memory blocks;
when it is determined that a bad memory block is present in the super block, determining whether there is a first replacement memory block in a plane, among the plurality of planes, coupled to the plane in which the bad memory block is present through a common way;
when it is determined that there is no first replacement memory block, regenerating the super block by replacing the bad memory block with a second replacement memory block in a die different from, but coupled to, the die in which the bad memory block is present, through the channel; and
storing data in the regenerated super block.

17. The data storage device according to claim 16, wherein the controller generates the super block based on memory blocks included in different planes.

18. The data storage device according to claim 17, wherein when the regenerated super block includes N memory blocks and M memory blocks of the N memory blocks are memory blocks which can be obtained by channel-interleaving, the controller assigns the regenerated super block such that data having a size being stored in (N-M) memory blocks are stored in the (N-M) memory blocks.
